(19) United States
(12) Patent Application Publication
(10) Pub. No.: US 2026/0312968 A1
(43) Pub. Date: Oct. 8, 2026

(54) NOVEL EDGE-BASED MULTI-AGENT SYSTEM FOR REAL-TIME DATA VALIDATION AND QUALITY GRADING

(71) Applicant: RAGHU KUL THILAK PARA, WINDSOR (CA)

(72) Inventor: RAGHU KUL THILAK PARA, WINDSOR (CA)

(21) Appl. No.: 19/170,236

(22) Filed: Apr. 4, 2025

(51) Int. Cl. H04L 9/40; H04L 41/16

(52) U.S. Cl. CPC H04L 63/1425; H04L 41/16; H04L 63/0869

(57) ABSTRACT

present invention relates to an edge-based multi-agent data validation system that executes specialized checks (schema, domain, semantic, anomaly) on incoming data streams in near real time. A coordinator module aggregates validation outputs and assigns a quality tier label (bronze, silver, or gold) to each data unit. This immediate classification prevents contaminated data from infiltrating downstream pipelines, thereby reducing bandwidth usage and storage overhead. Agents autonomously adapt via feedback loops, enabling domain rule updates and compressed AI model retraining on resource-constrained devices. The system thus ensures robust and traceable data integrity in distributed computing environments, particularly for IoT, edge analytics, and mission-critical applications.

### TECHNICAL FIELD

The present invention relates to the field of distributed data processing and validation edge system. Specifically, it addresses real-time data quality control in streaming data using a multi-agent architecture.

### BACKGROUND OF THE INVENTION

Data integrity lies at the core of effective analytics, machine learning outcomes, and real-time decision-making across industries. Yet, existing practices commonly funnel raw data from remote sensors, industrial equipment, and IoT devices into centralized data lakes or warehouses for cleansing and validation after ingestion. This post hoc approach incurs multiple drawbacks. First, it allows incomplete, erroneous, or anomalous data to persist in downstream processes, risking compromised analytics and inflated storage costs. Second, it often introduces significant latency, as validation may only occur hours—or even days—after data has already circulated within mission-critical systems.

Simultaneously, edge computing has emerged to reduce bandwidth consumption and mitigate latency by placing computational resources nearer to data sources. Although edge frameworks have seen success in preliminary filtering or aggregation tasks, they generally lack the sophistication to execute comprehensive data validation. Most existing solutions on the edge focus on trivial checks—like format verification or basic threshold detection—leaving advanced anomaly detection and semantic consistency assessments to powerful cloud-based engines. This fragmentation can lead to delays in identifying and isolating low-quality data.

The present invention addresses these limitations through a multi-agent system (MAS) architecture specifically designed for real-time data validation and tiered quality grading at or near the edge. The invention unifying edge computing principles with multi-agent collaboration, the proposed invention establishes a scalable, autonomous, and dynamic solution for early-stage data validation. It not only mitigates the cost and effort associated with post-ingestion cleansing but also delivers near-real-time insight into the trustworthiness of data, thereby enhancing operational efficiency, safety, and strategic decision-making.

### OBJECTS OF THE INVENTION

The primary object of this invention is to provide a multi-agent, edge-based data validation system that can verify incoming data streams in real time, significantly reducing the likelihood that low-quality or erroneous data will reach downstream analytics or storage.

Yet another object is to facilitate a tiered quality grading framework—bronze, silver, and gold—that enables immediate data classification at the edge, offering a clear, progressive measure of data reliability and fitness for further processing.

An additional object of this invention is to incorporate lightweight AI models, rule-based logic, and semantic checks directly on resource-constrained devices, thereby balancing computational efficiency with robust validation capabilities suitable for heterogeneous edge environments.

A further object is to provide a scalable, autonomous multi-agent architecture, wherein specialized agents (e.g., structural, anomaly detection, semantic) can be dynamically instantiated or migrated according to workload demands, ensuring optimum resource utilization and minimal latency.

Yet another object of the invention is to enable continuous improvement through an adaptive feedback loop, allowing validation rules, AI models, or thresholds to evolve with changing data profiles or domain constraints, thereby maintaining high accuracy over time.

These and other objects and advantages of the present invention will become readily apparent from the following detailed description taken in conjunction with the accompanying drawings.

### SUMMARY OF THE INVENTION

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

According to an embodiment of the present invention, a multi-agent data validation framework is deployed on an edge device to perform near-real-time quality assessment of incoming data streams. The edge device comprises at least one processor, a non-transitory memory, and a communication interface. A plurality of specialized validation agents executes on the processor, each agent being configured for a respective validation function, such as schema checks, rule-based domain constraints, semantic analysis, and anomaly detection using artificially intelligent models. The arrangement ensures that raw or partially processed data is subjected to multiple parallel checks prior to entering downstream storage or analytics infrastructures.

According to an embodiment of the present invention, the edge device is communicatively coupled to upstream sources (for instance, IoT sensors, gateways, or other data-producing endpoints) and downstream systems (such as data lakes, warehouses, or cloud platforms). Each data record received at the edge device is parsed into an internal message format, then distributed to specialized validation agents via a message-passing framework. Once the agents complete their respective validations, the results are collected by a coordinator module that aggregates agent outputs in order to determine a final quality tier label (bronze, silver, or gold).

According to an embodiment of the present invention, each specialized validation agent operates autonomously within its domain of expertise. A schema-validation agent checks for structural integrity, verifying that field names, data types, and record formats conform to a predefined schema definition. A domain-rules agent applies constraints defined by user configurations or known business logic, such as numeric ranges, mandatory fields, or permissible date formats. A semantic-validation agent evaluates context-dependent consistency, potentially referencing a local knowledge base or ontology to cross-verify that the data record is coherent with prior readings or correlated attributes.

According to an embodiment of the present invention, an anomaly-detection agent executes lightweight artificial intelligence models, which can be compressed or quantized to accommodate the limited computational resources typically available on edge hardware. The anomaly-detection agent may employ techniques such as isolation forests or neural autoencoders. The models are trained on representative historical data and infer anomalies by measuring deviations from learned patterns. In cases where the agent flags anomalous data, the coordinator module can lower the overall confidence score or escalate the record for additional checks.

According to an embodiment of the present invention, the coordinator module communicates with all specialized agents via an internal queue or topic-based mechanism, collecting validation outputs from each agent. Upon receiving the outputs, the coordinator module reconciles conflicts by referencing either a majority-voting scheme or a confidence-weighting algorithm. A majority-voting scheme assigns a final verdict (for instance, tagging the data as non-compliant) if more than half of the agents detect an issue. A confidence-weighting algorithm allows agents with higher historical accuracy to exert greater influence in cases of disagreement.

According to an embodiment of the present invention, the coordinator module assigns a tier label (bronze, silver, or gold) to each data unit or record. Bronze represents minimal compliance, indicating that only essential structural checks are satisfied. Silver denotes partial but substantial compliance, possibly lacking deeper semantic validation. Gold designates that all relevant validations, including anomaly detection and semantic checks, are satisfied with acceptable confidence. The assigned tier label is then appended to the data record's metadata for downstream consumption. If a record falls below a certain threshold, the coordinator module quarantines or flags it, preventing potentially erroneous data from propagating.

According to an embodiment of the present invention, an adaptive feedback loop is provided to improve validation accuracy over time. The edge device includes an adaptive feedback module, which gathers user input, revised domain rules, or downstream verification results (such as confirmations that certain flagged anomalies were indeed errors). The feedback signals trigger updates to agent configurations, thresholds, and possibly AI model parameters. In the event of recurring false positives, a reinforcement learning component may adjust sensitivity thresholds, thereby lowering unnecessary alarms. Conversely, recurrent false negatives can prompt tighter validation requirements.

According to an embodiment of the present invention, agent lifecycle management accommodates resource constraints inherent to edge environments. The system monitors CPU, memory, and network utilization on the edge device. If the monitored utilization exceeds a predefined threshold, one or more specialized validation agents may be paused or migrated to a nearby fog or micro-cloud node, which offers greater computational capacity. This migration process preserves real-time validation by splitting or transferring only the most computationally expensive workloads while maintaining essential rule-based checks on the local edge device.

According to an embodiment of the present invention, secure communication channels are employed for message exchange among the validation agents, coordinator module, and feedback module, ensuring data integrity and confidentiality. Encryption mechanisms or secure enclaves may be used, particularly where sensitive or personally identifiable data is being ingested. Additionally, each agent may authenticate its messages to prevent unauthorized manipulation of validation results or the injection of counterfeit data records.

According to an embodiment of the present invention, the system thereby offers significant technical benefits by reducing data contamination at the earliest point in the data pipeline. Only records meeting sufficient validation criteria are forwarded to downstream systems, which mitigates the bandwidth burden on core networks and decreases the processing overhead on centralized storage platforms. Furthermore, the multi-agent arrangement with immediate tier labeling provides traceability, so downstream analytics or decision-making modules can readily filter records based on assigned quality levels. This approach addresses the inherent limitations of post-ingestion validation and delivers a technically robust solution to the challenge of ensuring data quality in distributed, resource-limited, and latency-sensitive environments.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1-3 illustrate a novel edge-based multi-agent system for real-time data validation and quality grading, according to the present invention.

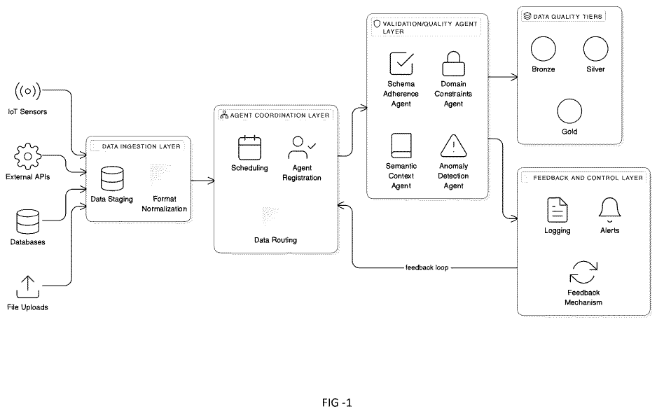

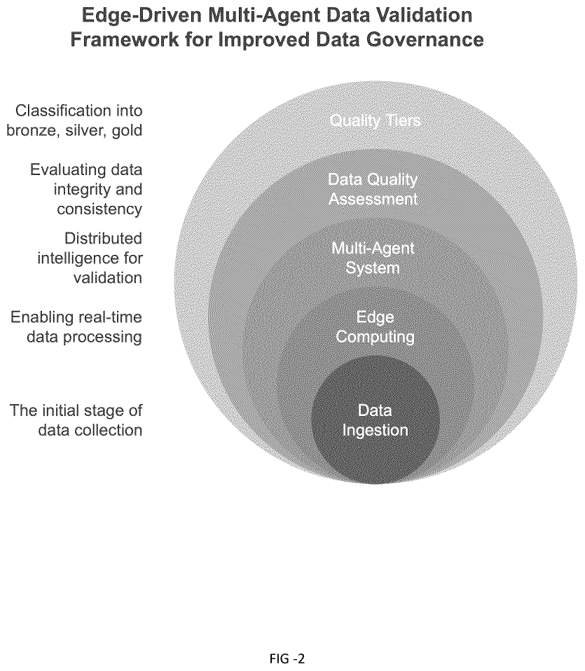

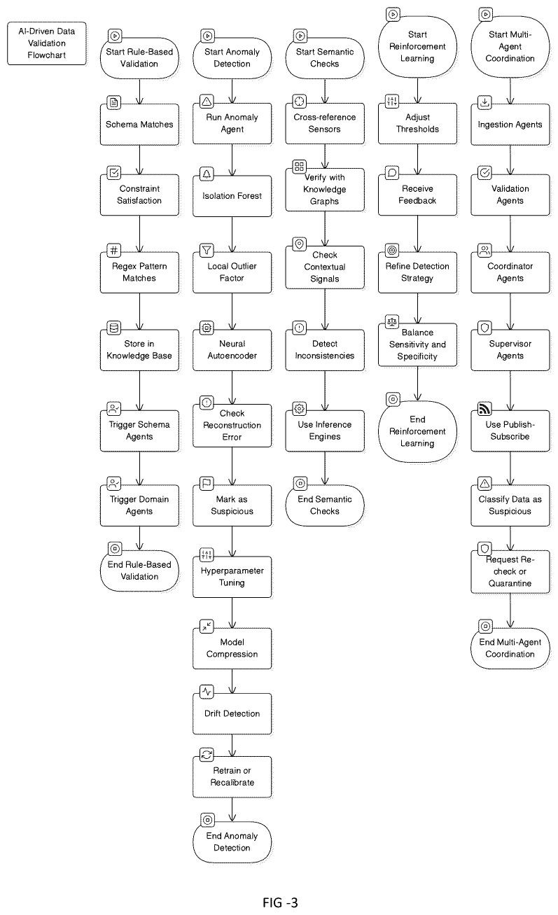

### DETAILED DESCRIPTION OF THE INVENTION

In the following detailed description, a reference is made to the accompanying drawings that form a part hereof, and in which the specific embodiments that may be practised are shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense. The various embodiments of the present invention provide for a novel edge-based multi-agent system for real-time data validation and quality grading.

According to an embodiment of the present invention, an edge-based data validation system for real-time verification and quality grading of incoming data streams is disclosed, comprising at least one edge device including a processor, a non-transitory memory, and a communication interface to receive data from one or more upstream sources, wherein the invention adopts a multi-agent system (MAS) paradigm deployed at or near data sources (the “edge”) to perform real-time data validation. In this system, the edge device can be any of a low-power IoT sensor employing lightweight embedded libraries, or a high-performance industrial gateway running containerized microservices (e.g., Docker, Kubernetes), thereby accommodating varying resource constraints and deployment models depending on device capabilities; a plurality of specialized validation agents executing on the edge device, each validation agent configured to perform a respective validation function selected from structural checks, rule-based domain checks, semantic consistency checks, or anomaly detection using at least one trained artificial intelligence model, and to generate a local validation output indicating compliance or non-compliance of the incoming data with predefined quality criteria, wherein such specialized agents address domain-specific constraints, anomaly detection, or semantic checks in a distributed, autonomous manner, a coordinator module communicatively coupled to the validation agents through an internal message-passing framework and configured to aggregate the local validation outputs, resolve discrepancies among the validation agents, and assign a quality tier label selected from bronze, silver, or gold to each data unit or record based on the aggregated validation results.

According to an embodiment of the present invention, the tiered classification enables real-time labeling of data quality so that low-quality or anomalous data can be immediately flagged, reducing downstream contamination, a data-forwarding interface operable to transmit data units and their assigned tier labels to downstream storage or processing nodes in real time and to filter or quarantine data flagged below a threshold tier, thereby preventing “dirty” or incomplete data from flowing into critical systems or data lakes, and an adaptive feedback module configured to update operational parameters of at least one validation agent in response to changes in domain rules, user feedback, or recurring anomalies, thereby enabling iterative self-improvement of data validation on the edge, wherein the feedback mechanism may employ reinforcement learning or self-adaptive rule engines to address dynamic data evolution and continuously refine detection thresholds.

According to an embodiment of the present invention, the system follows a decentralized, edge-based multi-agent architecture that (i) processes data closer to the source to reduce latency and network bandwidth usage, (ii) can be deployed on heterogeneous edge devices ranging from low-power IoT sensors (using embedded libraries) to high-performance industrial gateways (using containerized microservices), and (iii) classifies data into bronze, silver, or gold tiers reflecting increasing degrees of validation rigor. Multiple validation processes are performed on the edge device to reduce data contamination and network bandwidth usage by preventing low-quality data from propagating to downstream systems.

According to an embodiment of the present invention, a non-transitory computer-readable storage medium is provided, storing instructions that, when executed by at least one processor of an edge device, cause the edge device to perform a computer-implemented method for automated data validation and tier-based classification at the edge, wherein key strengths of this approach include reduced latency, minimized bandwidth overhead, and scalability through the multi-agent architecture, wherein said instructions further incorporate configurable communication protocols (e.g., MQTT, gRPC, or REST APIs) that adapt to network bandwidth and latency requirements, supporting integration with existing IoT ecosystems or industrial pipelines, the instructions further comprising dynamically allocating computational resources among the plurality of validation agents based on the detected volume or velocity of incoming data so as to optimize real-time performance under hardware constraints, thereby enabling autoscaling when data influx surpasses a predefined threshold and allowing fallback mechanisms if resource limitations arise, which addresses potential challenges posed by edge resource constraints or fluctuating data loads.

According to an embodiment of the present invention, the system is disclosed in which at least one specialized validation agent employs a compressed or quantized neural network for real-time anomaly detection, thereby reducing the processing load on the edge device while maintaining resource-efficient anomaly identification, wherein such techniques (e.g., pruning, “tiny ML” approaches) are crucial for sustaining AI-driven checks on limited hardware while still detecting significant deviations or sensor faults. Such compressed models are particularly suited for low-power IoT devices that lack the computational capacity for full-scale deep learning algorithms.

According to an embodiment of the present invention, the system is provided wherein a coordinator module appends the assigned quality tier label to each data record's metadata, such that downstream storage or analytics services can filter, aggregate, or quarantine the data based on the tier label, enabling traceability of data quality throughout a distributed environment, wherein real-time tiered classification (bronze, silver, gold) marks a shift from centralized post-hoc validation to proactive, edge-driven data governance, and wherein bronze, silver, or gold tiers align with increasing levels of validation checks—ranging from basic structural conformance to advanced anomaly and contextual verification—and allow downstream systems to implement distinct handling policies based on data reliability.

According to an embodiment of the present invention, the system is disclosed in which at least one specialized validation agent incorporates an adaptive rule engine that automatically updates domain-specific constraints or schema definitions upon receiving new rules from a user interface, without requiring a full redeployment of the system, wherein the ongoing adaptation addresses the challenge of dynamic data evolution, ensuring that sensor behaviors or business logic changes are seamlessly integrated, and wherein this adaptive mechanism supports the system's real-time feedback loop, leveraging user or AI-driven insights to refine structural, semantic, or anomaly-detection criteria.

According to an embodiment of the present invention, the system is provided with a secured communication channel for message exchange among the validation agents, the coordinator module, and the adaptive feedback module, thereby preserving data integrity and confidentiality on the edge device and mitigating risks of malicious tampering or interception, wherein privacy and security concerns are critical in untrusted or remote edge environments, requiring robust encryption and authentication measures, and wherein this channel may be implemented with encryption protocols (e.g., TLS-over-MQTT or gRPC security) and is essential in distributed edge environments where data might traverse multiple intermediary nodes.

According to an embodiment of the present invention, a computer-implemented method for automated data validation and tier-based classification at an edge device is disclosed, comprising receiving a data stream originating from one or more sensors, gateways, or external data sources at the edge device's communication interface, distributing incoming data records to a plurality of specialized validation agents executing on the edge device's processor, each validation agent performing at least one of verifying data structure and schema adherence, applying domain-specific rules or constraints, detecting anomalies or outliers using a locally deployed artificial intelligence model, or assessing semantic consistency by cross-referencing metadata, location, or correlated sensor readings, collecting intermediate validation outputs from each validation agent at a coordinator module and resolving any conflicts among them, wherein conflict resolution may leverage majority voting, confidence weighting, or escalation to a manual review if significant disagreements persist, determining a final data-quality tier label (bronze, silver, or gold) for each data record based on a weighted or majority consensus of the validation agents, applying a filtering logic that segregates or quarantines data labeled below a predefined tier threshold to prevent unreliable data from entering critical systems, and updating at least one validation agent through an adaptive feedback loop in which new rules, retrained AI model parameters, or user corrections are propagated to the agent in real time, thereby minimizing downstream computational load, network bandwidth, and error propagation by validating and labeling data at the edge in a distributed, resource-efficient manner, wherein the system's tiered quality model aligns with reducing “dirty” data ingestion in data lakes or analytic pipelines, and wherein said validation agents may be containerized microservices on industrial edge gateways or embedded libraries on low-power sensors, and the majority or weighted consensus approach addresses potential discrepancies in structural, semantic, anomaly, or contextual checks.

According to an embodiment of the present invention, the method is disclosed wherein determining the final data-quality tier label includes a confidence-weighting algorithm that adjusts each validation agent's influence based on historical accuracy metrics, thereby giving greater weight to agents with higher past precision when assigning the final tier label, wherein the system's adaptive feedback mechanism tracks false positives and false negatives for each agent to refine these confidence scores continuously, addressing the potential challenge of varying agent performance over time.

According to an embodiment of the present invention, the method is provided wherein a computing-intensive validation agent is migrated to a fog node or micro-cloud upon detecting that local CPU or memory usage exceeds a predefined threshold, thereby sustaining real-time validation capabilities at the edge device without overloading local resources, wherein such adaptive offloading ensures that heavier computations, like complex AI-based anomaly detection or semantic reasoning, do not impede critical edge operations, and wherein such offloading can be triggered by an autoscaling policy within the multi-agent system to ensure uninterrupted high-priority checks remain on the edge.

According to an embodiment of the present invention, the method is disclosed in which updating at least one specialized validation agent includes applying reinforcement learning, such that if downstream analytics confirm a previously flagged data record was actually erroneous or valid, the agent adjusts its detection thresholds to reduce future false positives or false negatives, wherein the system's self-adaptive policies contribute to continuous improvement and reduced manual intervention, and wherein these iterative improvements are a core feature of the system's feedback loop, enhancing both anomaly-detection accuracy and semantic validation rules.

According to an embodiment of the present invention, the non-transitory computer-readable storage medium is provided, wherein the instructions configure the coordinator module to employ a majority-voting protocol to resolve conflicting validation outputs, such that if at least a predetermined majority of validation agents detect an anomaly or inconsistency, the assigned tier label for that data record is automatically set to bronze until further review, wherein majority voting can also be superseded by a confidence-weighted model in scenarios where certain agents (e.g., anomaly detection) have demonstrated higher reliability or domain knowledge, thereby ensuring robust yet flexible conflict resolution in a distributed, autonomous setting.

According to an embodiment of the present invention, the system is disclosed in which at least one specialized validation agent integrates a knowledge graph or ontology-based reasoning mechanism to verify semantic relationships among data fields or entities, thereby detecting context-specific inconsistencies in real time, wherein context-aware checks allow the system to move beyond simple rule-based validation and leverage domain knowledge (e.g., correlating multiple sensor streams, weather data, or location-based constraints) for heightened accuracy.

According to an embodiment of the present invention, the method is provided wherein specialized validation agents are dynamically instantiated or terminated on the edge device based on fluctuations in data volume or domain-specific processing demands, thereby maintaining an optimal allocation of computational resources while preserving real-time validation throughput, wherein this dynamic instantiation aligns with an autoscaling policy that monitors incoming data streams and agent CPU/memory usage to adapt to surges or lulls in traffic, enhancing the system's horizontal scalability and resilience at the edge.

According to an embodiment of the present invention, the method is disclosed for periodically offloading historical data to a training environment, retraining at least one artificial intelligence-based anomaly detection model, and automatically updating the model parameters on the edge device without requiring a full system downtime, wherein this process supports ongoing learning and addresses new patterns or domain shifts, ultimately improving detection accuracy over time, and wherein batch retraining may occur in the cloud or a fog node, and once validated, the optimized model is pushed back to the edge for continuous real-time validation.

According to an embodiment of the present invention, the method is provided wherein, upon detecting insufficient hardware resources or limited bandwidth, the system automatically reverts to a reduced set of validation checks, thereby ensuring that at least basic data integrity thresholds are maintained until sufficient resources become available again, wherein this fallback mechanism acknowledges potential resource constraints in remote edge deployments, preventing system lockup while safeguarding minimal validation requirements, and wherein edge nodes may fall back to minimal (bronze-tier) structural checks under critical conditions, deferring advanced (gold-tier) anomaly or contextual validation until resource levels recover.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

I claim

1. An edge-based data validation system for real-time verification and quality grading of incoming data streams, the system comprising:
(a) at least one edge device including a processor, a non-transitory memory, and a communication interface to receive data from one or more upstream sources,
wherein the edge device can be any of:
a low-power IoT sensor employing lightweight embedded libraries, or
a high-performance industrial gateway running containerized microservices (e.g., Docker, Kubernetes), thereby accommodating varying resource constraints and deployment models depending on device capabilities;
(b) a plurality of specialized validation agents executing on the edge device, each validation agent configured to: (i) perform a respective validation function selected from structural checks, rule-based domain checks, semantic consistency checks, or anomaly detection using at least one trained artificial intelligence (AI) model,
(ii) generate a local validation output indicating compliance or non-compliance of the incoming data with predefined quality criteria,
wherein each specialized validation agent can utilize different communication protocols (including MQTT, REST, gRPC, or message queues) depending on network bandwidth and latency requirements, and can be adapted to run in compressed or quantized forms of ML models to handle edge-device computational limits;
(c) a coordinator module communicatively coupled to the validation agents through an internal message-passing framework, the coordinator module being configured to: (i) aggregate the local validation outputs,
(ii) resolve discrepancies among the validation agents, and
(iii) assign a quality tier label selected from bronze, silver, or gold to each data unit or record based on the aggregated validation results,
wherein the bronze, silver, gold criteria respectively denote increasing validation rigor from basic structural checks (bronze) to full anomaly and contextual validation (gold);
(d) a data-forwarding interface operable to transmit data units and their assigned tier labels to downstream storage or processing nodes in real time and to filter or quarantine data flagged below a threshold tier; and
(e) an adaptive feedback module configured to update operational parameters of at least one validation agent in response to changes in domain rules, user feedback, or recurring anomalies, thereby enabling iterative self-improvement of data validation on the edge,
wherein the system:
performs multiple validation processes on the edge device to reduce data contamination and network bandwidth usage by preventing low-quality data from propagating to downstream systems,
may dynamically spawn or terminate additional agent instances as data volume or velocity fluctuates, and
includes a secured communication channel to preserve data integrity and confidentiality in edge environments susceptible to malicious tampering or interception.

2. A computer-implemented method for automated data validation and tier-based classification at an edge device, the method comprising:
(a) receiving, at the edge device's communication interface, a data stream originating from one or more sensors, gateways, or external data sources,
wherein said interface can adopt MQTT for lightweight IoT communications, REST APIs for structured data ingestion, or event-driven message queues for asynchronous validation;
(b) distributing incoming data records to a plurality of specialized validation agents executing on the edge device's processor, each validation agent performing at least one of:
(i) verifying data structure and schema adherence,
(ii) applying domain-specific rules or constraints,
(iii) detecting anomalies or outliers using a locally deployed AI model, and
(iv) assessing semantic consistency by cross-referencing metadata, location, or correlated sensor readings,
wherein each agent may be containerized or embedded, depending on the device's available memory, CPU resources, or battery constraints, and may operate under a reduced validation strategy if resources become scarce;
(c) collecting, at a coordinator module, intermediate validation outputs from each validation agent and resolving any conflicts among them, wherein such conflicts may arise from varying agent confidence levels or divergent anomaly thresholds;
(d) determining, by the coordinator module, a final data-quality tier label (bronze, silver, or gold) for each data record based on a weighted or majority consensus of the validation agents,
wherein the bronze tier indicates minimal checks, the silver tier indicates structural and semantic coherence, and the gold tier indicates full anomaly detection and contextual cross-checking (e.g., referencing external APIs or weather data);
(e) applying a filtering logic that segregates or quarantines data labeled below a predefined tier threshold, thereby preventing unreliable data from entering critical systems; and
(f) updating at least one validation agent through an adaptive feedback loop, wherein new rules, retrained AI model parameters, or user corrections are propagated to the agent in real time,
wherein the method:
minimizes downstream computational load, network bandwidth, and error propagation by validating and labeling data at the edge in a distributed, resource-efficient manner,
enables dynamic scaling of agent processes in response to real-time data influx or high-velocity streams, and
may revert to basic structural checks only if hardware resources or network bandwidth become insufficient to sustain full validation.

3. A non-transitory computer-readable storage medium storing instructions that, when executed by at least one processor of an edge device, cause the edge device to perform the method of claim 2, the instructions further comprising dynamically allocating computational resources among the plurality of validation agents based on the detected volume or velocity of incoming data, so as to optimize real-time performance under hardware constraints,
wherein said dynamic allocation may include:
autoscaling containerized agents on higher-capacity edge gateways,
simplifying or skipping advanced validations on lower-capacity IoT devices, and
shifting some validation tasks to nearby fog nodes or micro-clouds when the local device exceeds a predefined resource threshold.

4. The system of claim 1, wherein at least one specialized validation agent employs a compressed or quantized neural network for real-time anomaly detection, thereby reducing the processing load on the edge device while maintaining resource-efficient anomaly identification,
wherein compression or quantization is particularly adapted for low-power or battery-operated IoT endpoints that lack sufficient CPU/GPU capabilities for large-scale AI models.

5. The system of claim 1, wherein the coordinator module appends the assigned quality tier label to each data record's metadata, such that downstream storage or analytics services can filter, aggregate, or quarantine the data based on the tier label, enabling traceability of data quality throughout a distributed environment,
wherein different downstream nodes (e.g., data lakes, real-time dashboards, or batch analytics systems) can use the bronze, silver, gold labels to implement tiered data-handling policies or selective ingestion rules.

6. The system of claim 1, wherein at least one specialized validation agent incorporates an adaptive rule engine that automatically updates domain-specific constraints or schema definitions upon receiving new rules from a user interface, without requiring a full redeployment of the system,
wherein such rule engine may adapt to changing domain criteria (e.g., permissible value ranges, new sensor types) or accommodate on-the-fly modifications to handle emerging application needs.

7. The system of claim 1, further comprising a secured communication channel for message exchange among the validation agents, the coordinator module, and the adaptive feedback module, thereby preserving data integrity and confidentiality on the edge device and mitigating risks of malicious tampering or interception,
wherein this secured channel can be implemented via TLS-encrypted MQTT or gRPC with mutual authentication, depending on network and device capabilities.

8. The method of claim 2, wherein determining the final data-quality tier label includes a confidence-weighting algorithm that adjusts each validation agent's influence based on historical accuracy metrics, thereby giving greater weight to agents with higher past precision in assigning the final tier label,
wherein the system maintains performance logs for each agent's false positive or false negative rates and employs these metrics during tier-resolution to bolster the reliability of consensus-based decisions.

9. The method of claim 2, further comprising migrating a computing-intensive validation agent to a fog node or micro-cloud upon detecting that local CPU or memory usage exceeds a predefined threshold, thereby sustaining real-time validation capabilities at the edge device without overloading local resources,
wherein such migration enables hybrid validation—lighter checks remain local, while heavier anomaly detection or contextual cross-referencing shifts to a more capable node.

10. The method of claim 2, wherein updating at least one specialized validation agent includes applying reinforcement learning, such that if downstream analytics confirm a previously flagged data record was actually erroneous or valid, the agent adjusts its detection thresholds to reduce future false positives or false negatives,
wherein this update process aligns with the iterative feedback loop described in the MAS architecture, continuously refining validation parameters at the edge.

11. The non-transitory computer-readable storage medium of claim 3, wherein the instructions configure the coordinator module to employ a majority-voting protocol to resolve conflicting validation outputs, such that if at least a predetermined majority of validation agents detect an anomaly or inconsistency, the assigned tier label for that data record is automatically set to bronze until further review,
wherein the majority-voting threshold can be adapted based on real-time observations of agent reliability or domain-criticality of the data.

12. The system of claim 1, wherein at least one specialized validation agent integrates a knowledge graph or ontology-based reasoning mechanism to verify semantic relationships among data fields or entities, thereby detecting context-specific inconsistencies in real time,
wherein such reasoning may also incorporate external contextual data (e.g., location, time-of-day, or concurrent sensor readings) for improved semantic validation.

13. The method of claim 2, further comprising dynamically instantiating or terminating specialized validation agents on the edge device based on fluctuations in data volume or domain-specific processing demands, thereby maintaining an optimal allocation of computational resources while preserving real-time validation throughput,
wherein an autoscaling manager or coordinator logic monitors inbound data rates and agent CPU usage to adjust the number and type of running agents on demand.

14. The method of claim 2, further comprising periodically offloading historical data to a training environment, retraining at least one AI-based anomaly detection model, and automatically updating the model parameters on the edge device without requiring a full system downtime,
wherein retraining can involve batch processing in the cloud or fog node, and the updated model is pushed to the edge device once validated, preserving continuous operation.

15. The method of claim 2, wherein upon detecting insufficient hardware resources or limited bandwidth, the system automatically reverts to a reduced set of validation checks, thereby ensuring at least basic data integrity thresholds are maintained until sufficient resources become available again,
wherein the fallback mode prioritizes structural or basic semantic checks (bronze-tier) and defers anomaly detection or contextual cross-referencing to future cycles or offloaded environments.
